(19) United States
(12) Patent Application Publication
(10) Pub. No.: US 2008/0247205 A1
(43) Pub. Date: Oct. 9, 2008

(54) Controlling apparatus of an AC LED string

(76) Inventor: Chin-Weih Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/783,313

(22) Filed: Apr. 9, 2007

(51) Int. Cl. H02M 7/06; H02M 1/00

(52) U.S. Cl. 363/126; 363/146

(57) ABSTRACT

The invention relates to a controlling apparatus of an AC LED string, which includes a controller to control the string being capable of flickering or totally unflickering very easily. The apparatus can also connect an adjustable resistance for application on a string with various numbers of LEDs. The apparatus includes at least one set of a pair of slots with different shapes or sizes at output ends for connecting with the LED string correctively that obtains improvement and utilization.

### BACKGROUND OF THE INVENTION

In Using a conventional AC LED string, it is very uncomfortable because the light of LEDs will continuously flicker under the AC power supply. Though this might be acceptable by consumers in some specific situation, it cannot satisfy all. Accordingly, it is necessary to prepare another DC LED string for replacement. That is the conventional LED string can only provide a single lighting effect based on different input current of power, including a flickering effect and a totally unflickering effect. If users want to have two lighting effects, they must prepare two LED strings that will be lack of economic and utilization.

### SUMMARY OF THE INVENTION

It is therefore a primary object of the invention to provide a controlling apparatus of an AC LED string, which can be easily applied to control a single string having two lighting effects respectively. Now, accompanying with the following drawings, the character of the present invention will be described here and after.

### BRIEF DESCRIPTION OF THE DRAWINGS

FIG. 1 is an electric circuit diagram of a controlling apparatus according to the present invention.

FIG. 2 is a modified electric circuit diagram of FIG. 1.

FIG. 3 is another modified electric circuit diagram of FIG. 1.

FIG. 4 is a modified electric circuit diagram of FIG. 2.

FIG. 5 is a modified electric circuit diagram of FIG. 3.

FIG. 6 is an exploded perspective view showing a controlling apparatus according to the present invention.

FIG. 7 is an assembled top plan view of FIG. 6.

### DETAILED DESCRIPTION OF THE PREFERRED EMBODIMENT

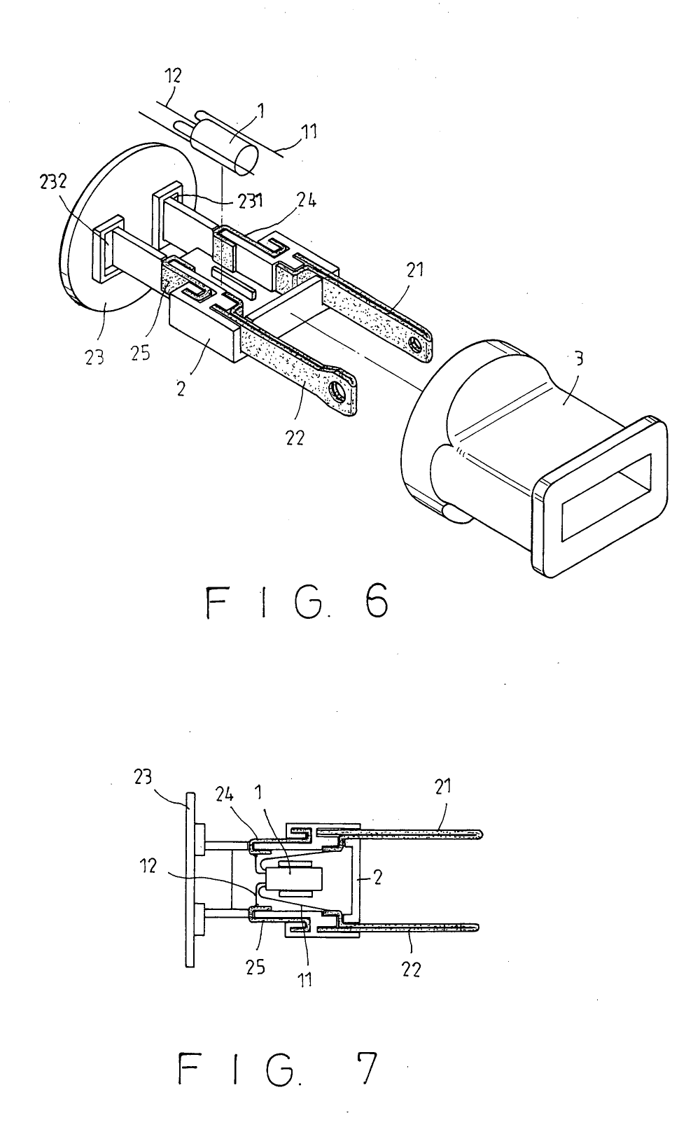

Referring to FIG. 6 and 7 first, the present invention relates to a controlling apparatus, which includes a controller (2) and a connector (2). The connector, (2) has its one side connect with two straight metal slices (21), (22) and has the other side form a plate (23) with at least one set of a pair of slots (231), (232) having various shapes or sizes. Two folded metal slices (24), (25) are received in the connector (2) at a place relating to the slots (231), (232). A shell (3) is provided to cover the connector (2). The controller (1) can be a bridge rectifier, which has two input ends (11) connect with two straight metal slices (21), (22) and has two output ends (12) connect with two folded metal slices (24), (25).

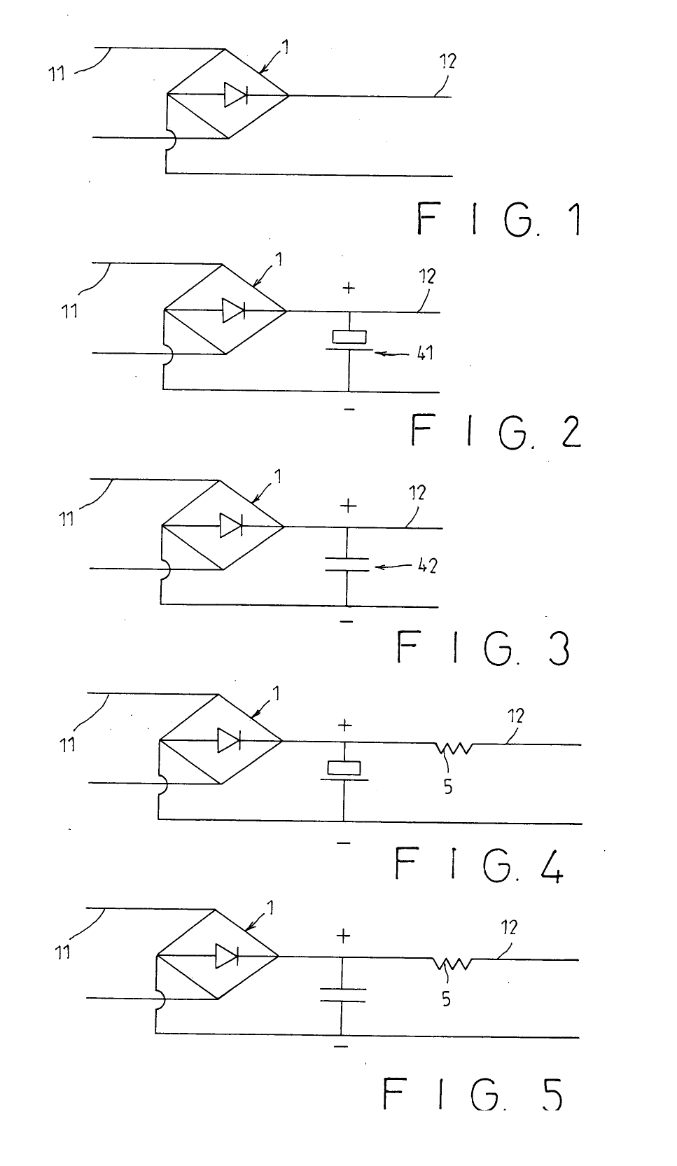

As shown in FIG. 1, when the metal slices (21), (22) connect with an AC power supply, the controller (1) can convert the voltage from AC to DC at output ends, for example the output end connecting to the folded metal slice (24) is positive pole and the other connecting to slice (25) is negative pole. Hence, the controlling apparatus according to the present invention can be provided for connecting an AC LED string directly and then the AC LED string can connect to an AC power supply to have a totally unflickering effect. When taking off the controlling apparatus, the AC LED string becomes a flickering light string again. The control of this change is very easy and convenient.

Please refer to FIG. 2 and 3, since there would be existed wave impulse under AC power supply, an electrolytic capacitor (41) or a capacitor (42) can be provided between two output ends (12) for solving the problem. Further, a fixed or adjustable resistance (5) is capable of connecting with one output end (12) for use, as shown in FIG. 4 and 5, when the string has different number of LEDs.

It will be readily understood and appreciated that numerous omissions, changes and additions may be made without departing from the spirit and scope of the invention. That is the about mentioned embodiment is only exemplary and is not to limit the scope of the invention. Any modification with the same merit will be still claimed in the present invention.

I claim:

1. A controlling apparatus of an AC LED string including a controller and a connector, wherein the connector has its one side connect with two straight metal slices and has the other side form a plate with at least one set of a pair of slots, two folded metal slices received in the connector at a place relating to the slots, and a shell provided to cover the connector.

2. A controlling apparatus of an AC LED string as claimed in claim 1, wherein the controller is a bridge rectifier.

3. A controlling apparatus of an AC LED string as claimed in claim 1, wherein an electrolytic capacitor or a capacitor is connected between two output ends of the controller.

4. A controlling apparatus of an AC LED string as claimed in claim 1, wherein a fixed or adjustable resistance is connected with one output end of the controller.

5. A controlling apparatus of an AC LED string as claimed in claim 1, wherein the slots of the place have various shapes or sizes.
